(19) United States
(12) Patent Application Publication
(10) Pub. No.: US 2021/0214154 A1
(43) Pub. Date: Jul. 15, 2021

(54) DEVICE FOR WASTE SEGREGATION AND COLLECTION OF SEGREGATED WASTE

(71) Applicant: BINE sp. z o.o, Dabrowa (PL)

(72) Inventors: Marcin ?otysz, Poznan (PL); Jakob Lubonski, Rokietnica (PL); Slawomir Wroblewski, Mielecin Szczecinski (PL)

(21) Appl. No.: 16/960,008

(22) PCT Filed: Dec. 27, 2018
(86) PCT No.: PCT/IB2018/060632

§ 371 Date: Jul. 2, 2020

(30) Foreign Application Priority Data
Dec. 28, 2017 (PL) P.424101

(51) Int. Cl. B65F 1/00; B65F 1/16; B65F 1/14

(52) U.S. Cl. CPC B65F 1/006; B65F 1/1607; B65F 1/1405; B65F 2210/128; B65F 2001/008; B65F 2210/168; B65F 2220/101; B65F 2210/1443

(57) ABSTRACT

The subject of the invention is a device for waste segregation and collection of segregated waste with a waste recognition, segregation and distribution section, a compression mechanism and storage bins is distinguished by the storage bins (15)(16) which have fill level sensors and which are inserted in the guideways of the base (13), directly over one of the side storage bins (15) there is a throwing box attached to the casing, with a throwing tunnel (9) and with a lid with a sensor that detects whether the lid is open or closed (4), above the bins (16) on a system of horizontal guideways (12), which are attached to the casing, there is a distribution cart (10) that moves sideways on the guideways, with a power system with a gear motor, which is controlled with a control system, the distribution cart (10) has a throwing mechanism (14)—at least one automatic throwing lid (11), the distribution cart works with its own throwing box with a lid with a sensor that detects whether its closed or open (6), within the throwing channel of the throwing box (6) there is a sensor of the waste recognition system—a camera.

This application claims the benefit of PCT Patent Application No. PCTIB2018060632 published as WO2019130225 filed Dec. 27, 2018 which claims benefit of Polish Patent Application No. PL20170424101, titled “DEVICE FOR WASTE SEGREGATION AND COLLECTION OF SEGREGATED WASTE,” filed by Marcin Lotysz, et al., on Dec. 28, 2017.

This application incorporates the entire contents of the foregoing application(s) herein by reference.

The subject matter of the invention is a device for waste segregation and collection of segregated waste; an intelligent, computerized waste bin whose unique feature is the ability to autonomously recognize the type of material of the waste that is being placed inside and sort it to the relevant chamber.

Municipal waste is one of the most important environmental issues worldwide. Currently in Poland about 11 million tonnes of waste are municipal waste.

Waste segregation with separation according to types of raw materials that the waste is made of is one of the methods to limit the amount of utilized waste. Recovered resources, in accordance to the recycling idea, is reused in production of new materials.

Waste segregation for recycling is often done at the source—by the person who produces and disposes the waste.

Special bins with segregation systems are used in order to facilitate waste segregation.

From the German patent description DE19622183 (A1) a device that collects and sorts mainly glass waste is known, with a recognition system based on a barcodes or EAN codes or geometrical shapes scanner, with a sorting system based on a gravity mechanism with a flap system. A similar gravitational sorting system is described in WO9529469 (A1) where the object identification is based on an optical beam, the system however is designed to sort mostly glass waste.

A similar recognition and sorting philosophy is represented by the Polish patent description P.412689 that describes a way to segregate waste, especially municipal waste, based on results of barcodes scanning.

From another Polish patent description P.412689 a waste sorter is known, with a drop box coupled to a press, a set of sensors and a controller, however signals from sensors are collected during the process of crushing the waste with the press, basing of physical features of the crushed waste. Basing on this information, the decision about the relevant disposal is made.

From the Chinese utility model CN204751129 (U) a waste bin is known, with a CCD camera for waste recognition and a communication system with the person who throws the waste in, however in this case, the sorting is done manually by giving instructions to the user about which bin is the proper one.

The patent description EP0092164 reveals a way of treating waste, in which objects are recognized on the basis of ultrasonic spectrum or electrical conduction, with a system that compacts fractions and treats them afterwards, e.g. by crushing.

The patent description EP0444745 (A1) shows a tool to sort out iron particles from other, non-iron particles in which objects are crushed and transported via a conveyour and sorted with a magnetic plate.

From the description CN105775531 (A) a multifunctional device for sorting of waste in households is known, with an inductive access control panel system, a communication system, with a recognition system based on a barcode analysis or an analysis of fixed pictures of packaging stickers.

From another utility model CN105564864 (A) a recognition and sorting system of hazardous waste is known, based on an analysis of pictures and on an analysis of data from the ionizing radiation sensor for hazardous waste identification. The methodology consist of using a cloud for image recognition, which poses the necessity of constant internet connection data processing, outside of the device. According to the invention, the object recognition happens directly in the device without the requirement for internet connection, which is beneficial for the speed and universality of the device.

From the description of the utility model CN204368811 (U) a smart waste bin is known as well, with a solar power system, in which the waste recognition system is based on multiple sensors, including an optical, laser and ultrasonic sensor.

The utility model CN205555207 (U) describes a solution where the optical object recognition system is attached directly over the transmission belt above compartments for sorted and unsorted waste.

In state of the art the use of processing units and communication devices for maintaining the bins is known as well. The utility model CN205060548 (U) a management system of a smart portable bin, with Wi-Fi communication systems, GPS systems or processing units. Information gathered by the sensors are sent to the relevant service and processed according to the adopted procedures. The description CN106144305 (A) is based on a similar concept, revealing a waste bin with a camera and a transmitter for informing the relevant services about the fill level of the bin.

Various methods of waste compression in waste containers are known as well, e.g. the utility model description CN205738983 (U) reveals the use of crushers powered by electricity.

The utility model CN205555188 (U) describes another way of waste recognition, based on fixing and analyzing images in infrared radiation.

The utility descriptions CN205366732 (U) or CN204399890 describe bins with waste collection tanks for recyclable and unrecyclable materials, with a screen that enables interaction with the users, especially displaying ads or video tutorials.

From the American patent description US2015081090 (A1) a method of material sorting is known based on their visual features (3D object recognition system).

From the patent description KR20100093905 (A) a sorting device is known, that is based on sensors which recognize metal objects, shape and color as well as on near-infrared spectroscopy sensors.

The invention is different from the known state of art because it does not focus on multiplying recognition systems or waste segregation. Its main objective is to adapt a complex and effective waste segregation, as cheap in production as possible. So far the known systems are designed for industrial use and they are of large or very large sizes. The solution according to the invention is a compact device in a size that allows to use the device in offices and households. On the other hand, the known systems are based on multisensory systems, while the solution according to the invention is based on a monosensory system that enables the recognition of all types of waste.

The subject of the invention is a device for waste segregation and collection of segregated waste which has a waste recognition, segregation and distribution section, a compression mechanism and storage bins. Four storage bins have fill level sensors and are inserted in the guideways of the base.

Directly above one of the side storage bins there is a throwing box attached to the casing, with a throwing tunnel. The lid of the throwing box has sensors that detect whether the lid is open or closed. This bin is for the collection of organic and mixed waste that is not sorted.

The remaining storage bins are for the collection of recyclable waste: glass, plastics and paper.

Above these bins on a system of horizontal guideways which are attached to the casing, there is a distribution cart that moves sideways. This cart is moved on the guideways with a power system with a gear motor. The motion of the cart is controlled with a control system.

The distribution cart has a throwing mechanism, which uses at least one throwing lid. The cart has its own throwing box, attached to the casing. This throwing box also has a lid with a sensor that detects whether the lid is closed or open. Within the throwing channel of the throwing box there is a waste recognition system that uses a camera. The waste recognition process is conducted when the cart is in the starting position and then the cart is moved above the relevant bin.

In preferable variant in the back of the frame, behind the inserted central bins, there is a vertical base frame of the moveable frame of the crushing mechanism that work with the middle storage bins for the collection of plastic and paper waste. The crushers have pads with flap mechanisms and they enable the compression of plastic and paper waste.

The moveable frame of the crusher mechanism is powered with a gear motor connected to a control system.

In the optimal option, the device has a cubic shape, and the casing of the device is made of wood on the sides, of metal or plastic on the front and on the back, the front of the casing contains the upper lift and the front lift. The front lift enables the access to the storage bins e.g. in order to empty them. The lids of the throwing boxes are included in the upper lift which is favorably tilting. In the back of the casing there is an access lid for service.

Preferably there is a touchscreen connected to a control system between the lids of the throwing box. The control system may contain a processing unit, controllers or outlets for sensors and communication interfaces, favorably Ethernet or Wi-Fi.

The invention brings the following benefits for the users:
it enables simple, fast, complex and efficient waste segregation
the device is simple in construction and cheap in building and maintenance
the communication systems adopted in the device enable efficient exploitation e.g. by alerting the relevant services about the necessity to take actions.

The embodiment of the device is shown on schematic drawings, in which

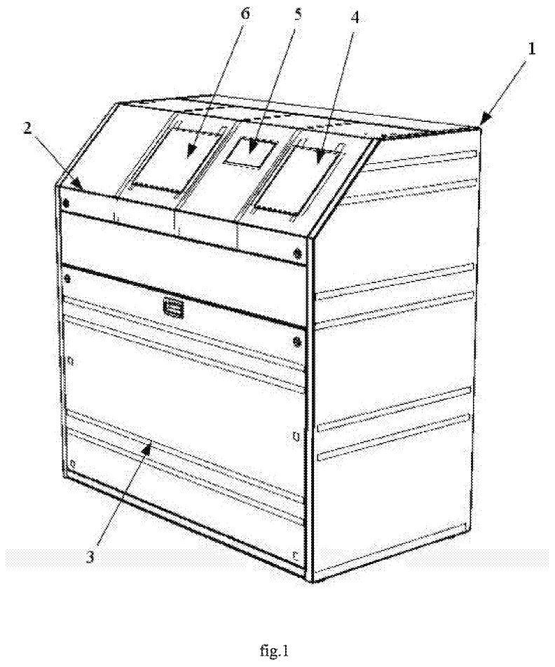

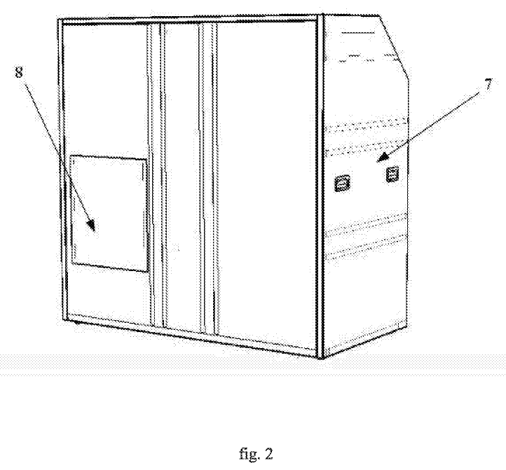

FIGS. 1 and 2 show parts of the casing,

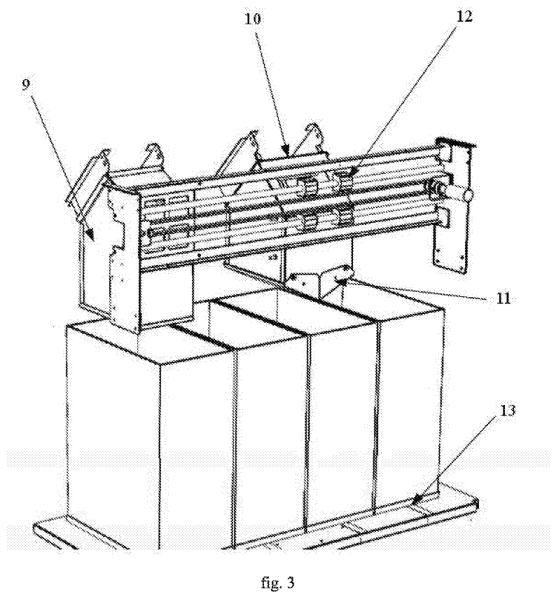

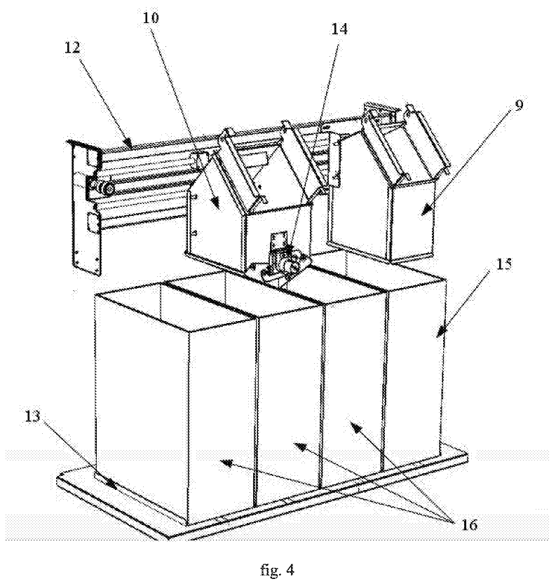

FIGS. 3 and 4 schematic parts of the waste recognition, segregation and distribution section,

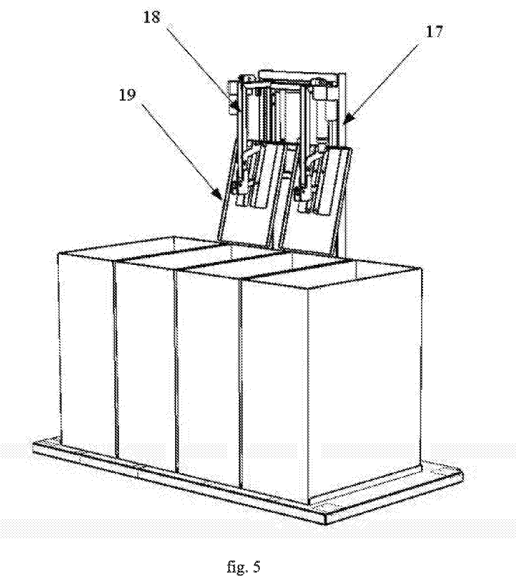

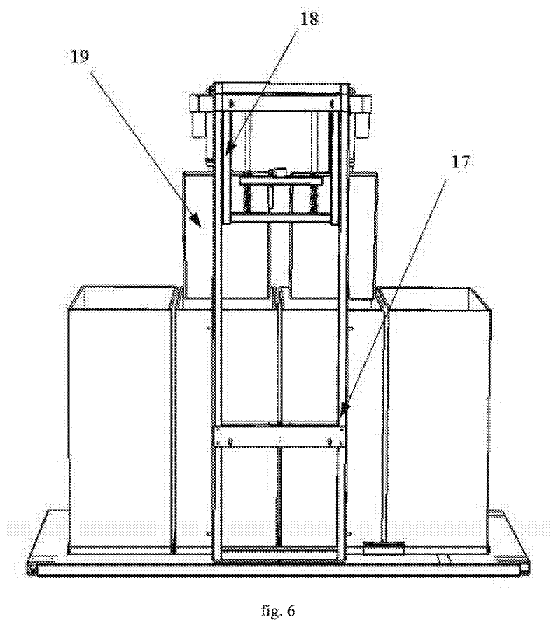

FIGS. 5 and 6 show parts of the waste compression section.

The device for waste segregation and collection of segregated waste in the example has a waste recognition, segregation and distribution section, a compression mechanism and storage bins. The device has four storage bins 15 and 16, that have fill level sensors which are not shown in the picture. The bins 15 and 16 are inserted in the guideways of the base 13. Directly over one of the side storage bins 15 there is a throwing box attached to the casing, with a throwing tunnel 9 and a sensor that detects whether the lid is open or closed 4.

Above the remaining bins 16 on a system of horizontal guideways 12, which are attached to the casing, there is a distribution cart 10 that moves sideways. The distribution cart 10 is moved on the guideways with a power system—that is not shown in the picture—with a gear motor. The motion is controlled with a control system.

Moreover the distribution cart 10 has a throwing mechanism 14—two automatic and controlled with a controller throwing lids 11. The distribution cart 10 works with its own throwing box with a lid with a sensor that detects whether its closed or open 6. Within the throwing channel of the throwing box 6 there is a sensor of the waste recognition system—a camera.

In another option, in the back of the frame, behind the inserted central bins 15 and 16, there is a vertical base frame 17 of the moveable frame 18 of the crushing mechanism. The crushers have two pads with flap mechanism. The moveable frame 18 is powered with a gear motor connected to a control system. The power system and the control system are not shown in the picture.

The device in the example has a cubic shape, and the casing of the device 1 is made of wood on the sides 7, of metal on the opening parts of the front and of plastic on back 8. The front lid enables the access to the storage bins e.g. in order to empty them. The lids of the throwing boxes 4 and 6 are included in the upper lift. Between the lids of the throwing boxes there is a touchscreen 5 connected to a control system. The opening part of the back casing is an access lid for service. In other options the whole casing can be made of metal or plastic panels.

The control system contains a processing units, a controller or outlets for sensor connections and communication interfaces Ethernet and Wi-Fi. On the back the casing there is an electrical power outlet, a Wi-Fi antenna and an Ethernet connector 19.

The device according to the invention is designed for indoor spaces, especially crowded places e.g. office buildings, institutions, airports, rail-way stations, exhibition areas, production facilities, etc. After small modifications the device can also be used in outdoor areas. The applied waste recognition system is universal and can be used in other recognition and segregation systems of waste or other things as well.

What is claimed is:

1. Device for waste segregation and collection of segregated waste with a waste recognition, segregation and distribution section, a compression mechanism and storage bins characterized in that the four storage bins (15)(16) which have fill level sensors and which are inserted in the guideways of the base (13), directly over side storage bin (15) there is a throwing box attached to the casing, with a throwing tunnel (9) and with a lid with a sensor that detects whether the lid is open or closed (4), above the bins (16) on a system of horizontal guideways (12), which are attached to the casing, there is a distribution cart (10) that moves sideways on the guideways, with a power system with a gear motor, which is controlled with a control system, the distribution cart (10) has a throwing mechanism (14)—at least one automatic throwing lid (11), the distribution cart works with its own throwing box with a lid with a sensor that detects whether its closed or open (6), within the throwing channel of the throwing box (6) there is a sensor of the waste recognition system preferably camera.

2. Device according to claim 1 characterized in that the back of the device, behind the guideway (12) for the inserted bins (15)(16) there is a vertical base frame (17) of the moveable frame (18) of the crushing mechanism with two pads with flap mechanism, the moveable frame is powered by a gear motor which is connected to a control system.

3. Device according to claim 1 or 2 characterized in that it has a cubic shape and the casing of the device (1) is made of wood on the sides (7), of metal or plastic on the opening parts of the front and of the back (8), the front lid and the tilt upper lid (2) with the lids of the throwing boxes are included in the front of the casing (3).

4. Device according to the claim 1, 2 or 3 characterized in that on the front tilting part of the casing (2) which contains the lids of the throwing boxes (4)(6), there is a touchscreen connected to a control system which contains a processing unit, a controller or outlets for sensor connections and communication interfaces for Ethernet or Wi-Fi.
